(19) United States
(12) Patent Application Publication
(10) Pub. No.: US 2008/0077496 A1
(43) Pub. Date: Mar. 27, 2008

(54) FURNITURE MARKETING PLAN

(76) Inventor: Beverly Ann Cotton, Farmington, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/860,688

(22) Filed: Sep. 25, 2007

Related U.S. Application Data
(60) Provisional application No. 60/826,796, filed on Sep. 25, 2006.

(51) Int. Cl. G06Q 30/00

(52) U.S. Cl. 705/14

(57) ABSTRACT

A furniture marketing system using a base company, numerous interior designers and trade partners which display the furniture.

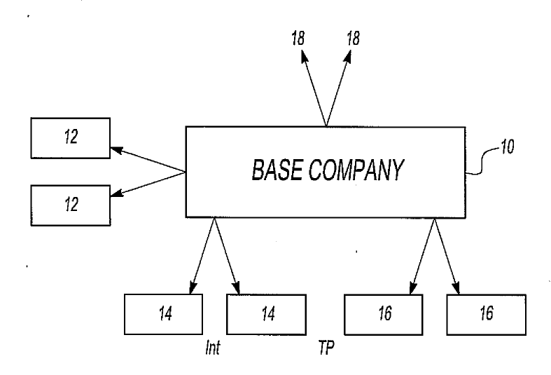

### CROSS-REFERENCE TO RELATED APPLICATIONS

This application claims priority of U.S. Provisional Patent Application Ser. No. 60/826,796 filed Sep. 25, 2006, which is incorporated herein by reference.

### BACKGROUND OF THE INVENTION

I. Field of the Invention

The present invention relates to a marketing plan for furniture.

II. Description of Related Art

Interior designers, many who work out of their homes, have difficulty buying furniture for resale to clients. Many manufacturers of furniture require a large buy-in before they will permit a retailer or designer to carry their product line. That buy-in can range from $10,000 to $50,000. Additionally, such manufacturers require annual minimum purchases in order for the retailer to maintain the right to sell the manufacturer's product.

Individual designers are unable to pay the buy-ins and minimums and thus are unable to obtain the high discounts given by furniture manufacturers to those who can. Consequently, many designers are limited to no, or very low, profit for furniture sales to their clients. Further, those designers have no samples to show their clients.

### SUMMARY OF THE INVENTION

The present invention provides a marketing plan which overcomes the above mentioned disadvantages of the previously known marketing plans for furniture.

In brief, a base company enters into agreements with different furniture manufacturers to purchase furniture from these manufacturers at the same price as the price paid by retail distributors or large design houses. Such discounts are available on a relatively high volume.

The base company then enters into individual agreements with numerous interior designers 14. Under these agreements, the designers pay a fee to the base company and the base company agrees to sell furniture to the designers at a fixed discount, e.g. 20% above the base company's cost. This, in turn, enables the interior designers to profitably resell the furniture to their individual clients at prices equivalent to or better than would be available to the customer at retail.

In order to enable the retail customer to see the furniture prior to purchase, the company also enters into numerous agreements with trade partners. Each trade partner has a retail outlet of some sort. Under the terms of these agreements, the trade partners designate a limited amount of floor space for the base company to display furniture. The base company then displays the furniture on the floor space at the trade partner.

In return for the designated floor space, the base company effectively drives the member interior designers and their clients to the premises of the trade partner to view the furniture. This then gives the trade partner the opportunity to sell its own goods to the designers and the clients.

### BRIEF DESCRIPTION OF THE DRAWING

A better understanding of the present invention will be had upon reference to the following detailed description when read in conjunction with the drawing which is a diagrammatic view of the method of the present invention.

### DESCRIPTION OF AN EMBODIMENT OF THE INVENTION

With reference to the drawing, a base company 10 enters into agreements with different furniture manufacturers 12 to purchase furniture from manufacturers at “net,” the same price as paid by retail distributors or large design houses. Furniture manufacturers 12 are willing to enter into such agreements with the base company 10 since the furniture manufacturers 12 anticipate high volume sales through the base company 10.

The base company 10 then enters into individual agreements with numerous interior designers 14. Under the agreements, for an annual fee paid by the designer, the base company 10 agrees to sell furniture to the designer 14 at a fixed discount, e.g. 20% above base company's cost (net). Since the base company is able to purchase furniture from the manufacturers 12 at net, the sale to the designer 14 at 20% above cost permits the base company to profit from such sales. Additionally, buying 20% above cost, the interior designers 14 are able to purchase the furniture from the manufacturers 12 through the base company 10 at 60% below Manufacturer's Suggested Retail Price (MSRP) for better than they would pay to other sources such as design centers, discount houses, or furniture stores whose discounts to designers are minimal.

The interior designers 14 are then able to resell the furniture to their individual clients at prices equivalent to or better than would be available to the customer at retail. This, in turn, enables the designer 14 to not only enhance customer loyalty, but also earn a profit. The base company also handles all the ordering, processing and delivery logistics for the designers, freeing them from dreaded tasks and allowing them to just select and sell.

The invention also solves the problem of where designers' clients can view furniture, upholstery and wood samples seen in magazines. The furniture industry is in flux with most middle to high-end furniture stores closing. Likewise, most major department stores no longer carry furniture. Clients have nowhere to see, feel and touch the furniture. Catalogs and online photographs are usually insufficient.

Because many people pay more for a room full of furniture than they do for a car, they have to see the furniture. To provide a showcase outlet for the furniture carried by the base company 10, the base company 10 enters into agreements with certain retailers called “trade partners.” These trade partners 16 may be smaller nonexclusive retail furniture outlets or related trades such as carpet stores, window furnishing stores or lighting stores. Under the terms of the agreements, the trade partners 16 designate a limited amount of floor space for the base company 10. The base company 10 then displays furniture and stocks sampling material of a particular manufacturer or manufacturers in that space.

In return for the designated space, the base company “drives” member designers and their clients to the trade partner to view the furniture. The trade partner then has the opportunity to sell its own wares to the designers and clients, be it drapes, flooring or lamps. The trade partners 16 also receive the deep discounts for base company's furniture which they can sell to their own retail customers at a good profit. The base company has numerous showcases where member designers can see and show furniture and still buy it from the base company for resale to clients at a profit. Member designers would buy from the base company and not the showcase trade partner because the trade partner would sell at more than it purchased for, that is, more than 20% above cost.

The trade partners 16 not only benefit from the increased traffic of designers from the base company 10 and their clients, but also because the trade partners 16 acquire furniture lines from the base company 12 at deep discounts without the large buy-ins for each manufacturer 12 or the required minimum annual sales. Thus the trade partner has another product for retail customers (furniture) and another profit source, without the up front costs.

In addition, the base company negotiates with retail stores 18 for discounts for member interior designers. Most retail stores provide designers with some sort of trade discount, but it is not uniform and only negotiated one-on-one. The standard discount is advantageous because designers typically complete the major part of a design job but fall short when it comes to obtaining the accessories which finish a room or a job. The hassle of opening small lines or negotiating with retail stores 18 for a discount on small products is a deterrent. The base company's marketing plan eliminates this problem for designers

From the foregoing, it can be seen that the marketing plan of the present invention provides a novel and advantageous method which enables interior designers and trade partners to sell their goods at prices equal to or even better than retail prices at large retail merchandisers and yet still maintain a profit. Having described my invention, however, many modifications thereto will become apparent to those of skill in the art to which it pertains without deviation from the spirit of the invention as defined by the scope of the appended claims.

I claim:

1. A method for marketing furniture comprising the steps of
establishing a base company which enters into agreements with furniture manufacturers to purchase furniture at discount,
enrolling member designers which purchase furniture through the base company on behalf of customers of the member designers at a preset amount above the cost of the furniture to the base company, said member designers selling the furniture to the customers for an amount greater than the cost to the member designers.

2. The invention as defined in claim 1 and further comprising the step of enrolling trade partners with showroom space to display furniture on a limited amount of the showroom space.

3. The invention as defined in claim 1 and comprising the step of each member designer paying a periodic fee to the base company.

4. The invention as defined in claim 3 wherein said fee is paid annually.
